(19) United States
(12) Patent Application Publication
(10) Pub. No.: US 2008/0010128 A1
(43) Pub. Date: Jan. 10, 2008

(54) Image-taking system

(75) Inventor: Ronald W. Allen, Ottawa (CA)

Correspondence Address: PERLEY-ROBERTSON, HILL & MCDOUGALL LLP, 1400-340 Albert Street, OTTAWA, ON, K1R 0A5, US

(73) Assignee: LightSpeed Studios Inc.

(21) Appl. No.: 11/452,197

(22) Filed: Jun. 14, 2006

(51) Int. Cl. G06Q 30/00

(52) U.S. Cl. 705/14

(57) ABSTRACT

An image-taking system that attracts the attention of a targeted consumer by offering the targeted consumer a free picture of an object, such as a newborn baby, and then, once the consumer is in interaction with the system, the system attempts to promote products and services of third parties that are related to the object, such as baby food and diaper services.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING

Not Applicable

### BACKGROUND OF THE INVENTION

The invention relates to an image-taking system and, in particular, it relates to an image-taking system that promotes products and services to certain users.

Although applicable for many applications, the present invention is particularly suitable for use in hospitals and will be described in that connection.

For years, advertisers and advertising agencies have been using various methods and techniques to capture the consumer's attention in order to advertise to the consumer a new product or service being sold.

For example, it is not uncommon to use sexual appeal in televised beer commercials in order to draw the viewer's attention to the television screen right before introducing the beer being advertised. Another advertising technique used to capture the consumer's attention is to use celebrities for advertising purposes. Since people are automatically drawn to familiar faces and personalities, advertisers are prone to using celebrities in televised commercials and on advertising billboards to attract the attention of the consumer.

Such advertising techniques can be broken down into two functions: (1) capturing the consumer's attention and (2) subsequently advertising the product or service for sale.

In addition to using visual “bait” to grab the consumer's attention, as discussed in the two examples above, other advertisers prefer using audio bait, such as by playing a popular song, to attract attention. Yet other advertisers use emotional bait. For example, myriad advertisements sent by mail are mailed in envelopes (or packages) marked with phrases such as “Free Stuff Inside” to induce the receiver—that is, the targeted consumer—to open the envelop and read further.

As long as there is competition between business institutions, there continues to be a need for advertising; and the better the business institution promotes its products and services, the better is its chance to beat its competition in the market. Hence, it can be appreciated that there exists a continuing need for more sophisticated advertising methods, techniques and systems. The present invention presents a new image-taking system that relies on above-discussed advertising principle to promote products and services to certain users.

### SUMMARY OF THE INVENTION

The present invention presents a system that lures/attracts the targeted consumer by offering the targeted consumer a free image (picture) of an object and then, once the consumer is in interaction with the system, the system attempts to promote third party products and services, which are related to the object.

In accordance with one aspect of the present invention, there is provided a system for taking an image of an object, the system comprising a station comprising at least one image-taking camera for taking the image of the object, a printer for printing the image to be taken, and an interactive computer terminal having a display screen and a keyboard. The interactive computer terminal is in operative communication with a storage medium, and the image-taking camera(s), the printer, and the interactive computer terminal are in operative communication.

The interactive computer terminal is adapted to require the input of contact information relating to the user or the user's nominee, to store the contact information in the storage medium, and to query the user if the user or the nominee is interested in receiving object-related information, object-related goods and/or object-related services from one or more pre-selected third party sources, and to input either a positive or a negative response to the query.

The system further comprises means for actuating the image-taking camera(s) once the positive or negative response is inputted, and for causing the printer to print the image once taken.

The interactive computer terminal is linked to a computer communication network, wherein the contact information inputted by users with the positive response and stored in the storage medium is accessible via the computer communication network from a remote physical location by the pre-selected third party sources.

Advantageously, the system of the present invention may be adapted to store the image once taken in the storage medium along with the contact information and a unique access code assigned to the image by the interactive computer terminal, and to cause the printer or a second printer to print the unique access code. The image stored in the storage medium then is accessible via the computer communication network from a second remote physical location by the user and/or the nominee utilizing the contact information and the access code.

Where the contact information includes an electronic address relating to the user or the nominee, the interactive computer terminal may be adapted to transmit the unique access code to that electronic address via the computer communication network.

The interactive computer terminal may be further adapted to query the user if the user or the nominee wishes to grant access to the stored image via the computer communication network to at least one remote party located at a third remote physical location and having a remote-party electronic address, to input either a positive or a negative response to the further query, and if the response to the further query is positive, to require the additional input of the remote-party electronic address of each of the remote parties for whom access is to be granted and transmit via the computer communication network a hyperlink to each inputted remote-party electronic address, wherein the remote parties can access the stored image by utilizing the hyperlinks.

In order to improve the quality of the image to be taken, the station may further comprise at least one lamp in operative communication with the image-taking camera(s) for illuminating the object at the time the image is taken. As will also be apparent, the computer communication network may be the World Wide Web.

Preferably, the display screen of the interactive computer terminal may be an interactive touch display screen, in which case the keyboard may be an onscreen keyboard.

In order to promote further advertising, the computer may be programmed to display on the display screen promotional information relating to the advertiser(s). For the same purpose, the system may even include a second display screen, preferably a high-resolution display screen, for the purpose of displaying such promotional information.

The image-taking system of the present invention provides businesses with a new approach to accessing the contact information of a certain percentage of their targeted consumers that have consented to their contact information being shared with these businesses.

### BRIEF DESCRIPTION OF THE DRAWINGS

The invention, its construction and operation will be best understood by reference to the following detailed description taken in conjunction with the accompanying drawings, in which:

FIG. 1A is a flow chart illustrating the various method steps utilized in the system of the present invention;

FIG. 1B is a flow chart illustrating the steps of an alternative embodiment of the invention to the one of FIG. 1A;

FIG. 1C is a flow chart illustrating the steps of yet another alternative embodiment of the invention to the one of FIG. 1A;

FIG. 2 is a flow chart illustrating additional steps to those of FIG. 1A or 1B which may be carried out by the system of the present invention; and

FIG. 3 is a flow chart illustrating additional steps to those of FIG. 2 that may be executed by the system of the present invention.

### DETAILED DESCRIPTION OF THE PREFERRED EMBODIMENT

The present invention presents an image-taking system that invites the attention of a targeted consumer by offering the targeted consumer a free picture of an object and then, once the consumer is in interaction with the system, the system attempts to promote an advertiser's products and services, which are related to the object.

The image-taking system of the present invention is ideal for use in hospitals offering free pictures of newborn babies, and which promotes the products and services of advertisers who cater to the baby marketplace. The invention will be described below with reference to such application; however, the image-taking system described herein is suitable for many other applications and is not limited to the hospital environment.

In the following description, the term “user” describes a person who is physically present at a station or kiosk for the purpose of causing the image to be taken. Such “user” is usually the parent or a person nominated by the parent to take a picture of a newborn.

Promoting and advertising agencies always try to promote and advertise the advertisers' products at venues where the advertisers' targeted consumer is likely to be present. For that reason, hospitals have always been considered as good venues to promote the products and services of businesses that cater to the baby marketplace.

The birth of a child is one of the happiest moments people experience. Parents have relied on personal cameras as well as third party photographers to capture the first images of their newborn baby. Also, some hospitals have introduced self-serve “baby kiosks” which, for a certain monetary charge, take photographs of newborn babies. The present invention takes advantage of the latter baby photography approach by converting baby picture-taking kiosks into promoting vehicles to promote the goods and services of third parties, such as baby food, life insurance and the like.

Traditionally, known baby picture-taking kiosks comprise (1) a camera, which may or may not be associated with a lamp for illuminating the baby at the time the image is being taken, depending on the amount of light expected at the area where the kiosk is to be placed; (2) a printer for printing the image; and (3) means for accepting payment.

Preferably, baby picture-taking kiosks have the camera housed by the kiosk and aimed at a space where a baby carriage can be parked. This is to facilitate the photograph-taking experience by allowing the user to take the picture of the baby without removing the baby from the carriage. Other kiosks may have the camera aimed at a space where the user can lay down the baby, such as a padded baby table.

The present invention converts a baby picture-taking kiosk into a marketing vehicle by offering free pictures (photographs) to parents of their newborns in return for an opportunity to promote to the parent the products and services of third parties (advertisers), who are in the business of baby-related products, services, and/or information and wish to target the parents of the newborn.

The foregoing is achieved by replacing the means for accepting payment by an interactive computer terminal (the “computer”) that includes a display screen and a keyboard, and is connected to a storage medium. The display screen may be an interactive touch display screen, in which case the keyboard may be an onscreen keyboard. One of the functions of the computer is to interact with the user, as will be described below, to promote newborn-related, third party supplied merchandise and services.

The computer is connected to a conventional computer communication network such as the World Wide Web or a smaller enterprise network such as a wide area network (WAN). As is well known in the art, the storage medium may be a part of another computer system (a “server”) located at a different physical location than the computer, and connected to the computer via the computer communication network.

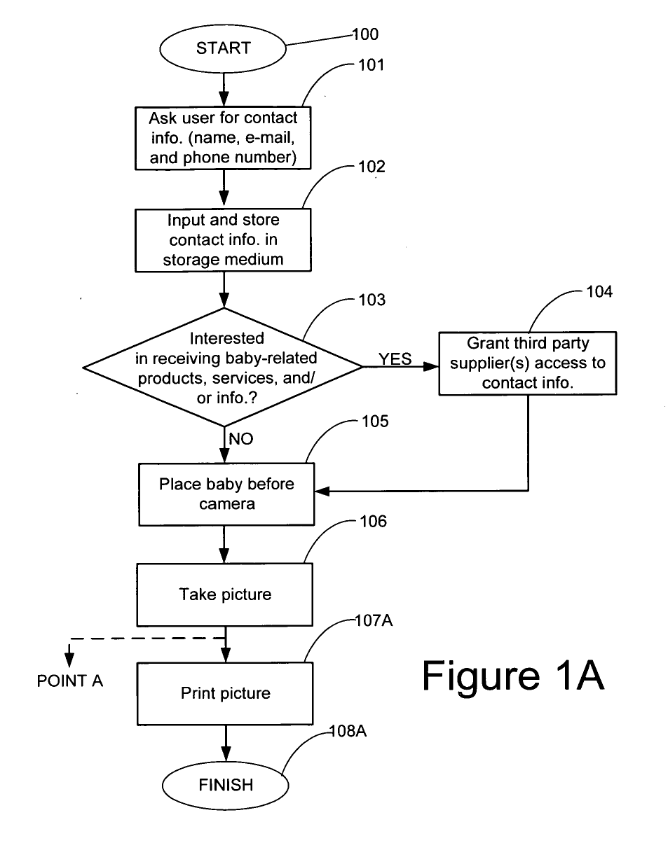

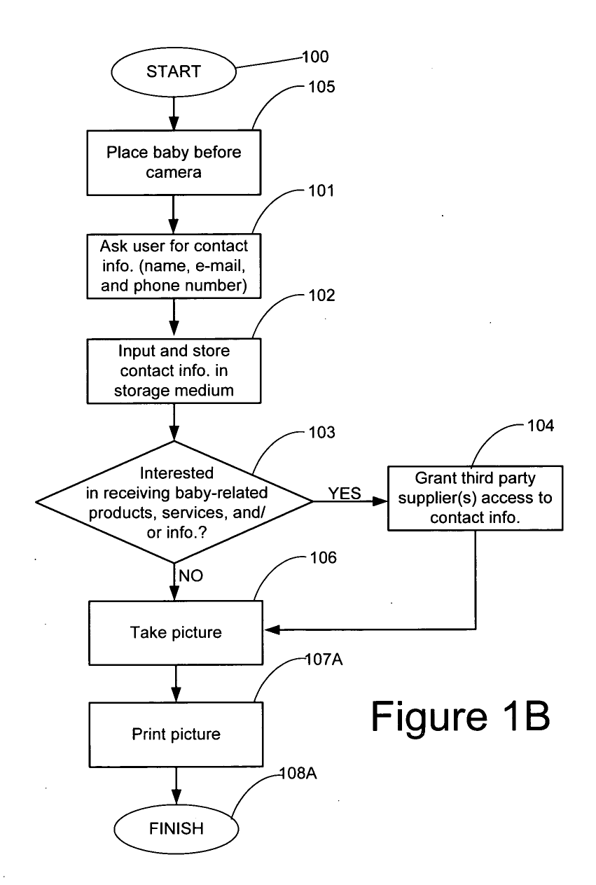

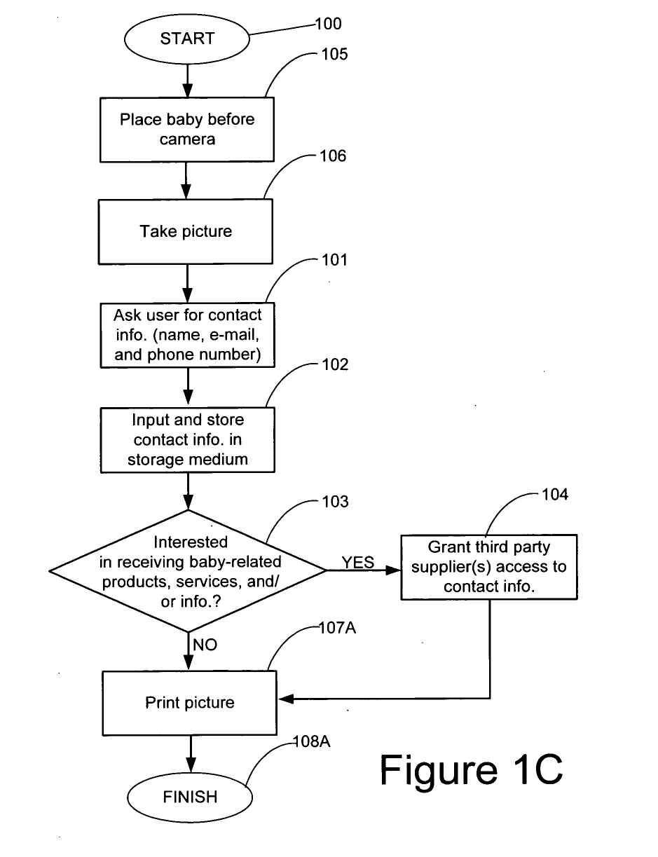

FIG. 1A illustrates a plurality of steps that are necessary to take a picture of a baby using the image-taking system of the present invention (the “system”). Once the user arrives at the kiosk and starts to use the system (step 100), the computer requires the user to enter his or her contact information; or the parents' contact information, where the user is not one of the parents, but a person nominated by them to take a picture of their newborn baby (step 101). The required contact information usually includes the name, telephone number, and electronic mail address of the user or one of the parents; however, the computer may be programmed to ask for any type of other contact information. For example, it could be programmed to request the parents' street address.

Once the user enters the information by using the keyboard of the computer, the computer inputs and stores the contact information in the storage medium (step 102). The computer subsequently inquires (step 103) if the user or the user's nominee—that is, the parents—would like to receive baby-related products (such as diapers, baby food, coupons for diapers or baby food, etc.), baby-related services (such as nanny or insurance services), and/or baby-related information (such as parental guiding points, baby-related tips, or baby-related brochures).

If the user enters a positive response to the inquiry of step 103, the computer grants one or more third parties who are in the business of providing baby-related products, services and/or information access to the contact information entered by the user and stored in the storage medium (step 104). By doing so, the third parties are then able to contact the user or user's nominee for further promotion or sale purposes.

The user then places the newborn baby before the camera (step 105) and actuates the camera to take the picture. Once the camera takes the picture (step 106), the computer (using the printer) prints a hard-copy of the picture for the user (step 107A), and terminates the process (step 108A).

It will be appreciated that placing the baby before the camera (step 105), could take place at any time in the process prior to taking the picture (step 106). For example, a user could place the baby in front of the camera (step 105) before being asked for his or the parents' contact information (step 101) and actuate the camera to take the picture (step 106) after responding to the inquiry of step 103. FIG. 1B illustrates that possibility.

As is apparent from the foregoing, various changes to the order of the described method steps may become obvious to those skilled in the art without departing from the essence of the invention. Another example to illustrate this is shown in FIG. 1C, where a user may place the baby in front of the camera (step 105) and actuate the camera to take the picture (step 106) before being asked for his or the parents' contact information (step 101).

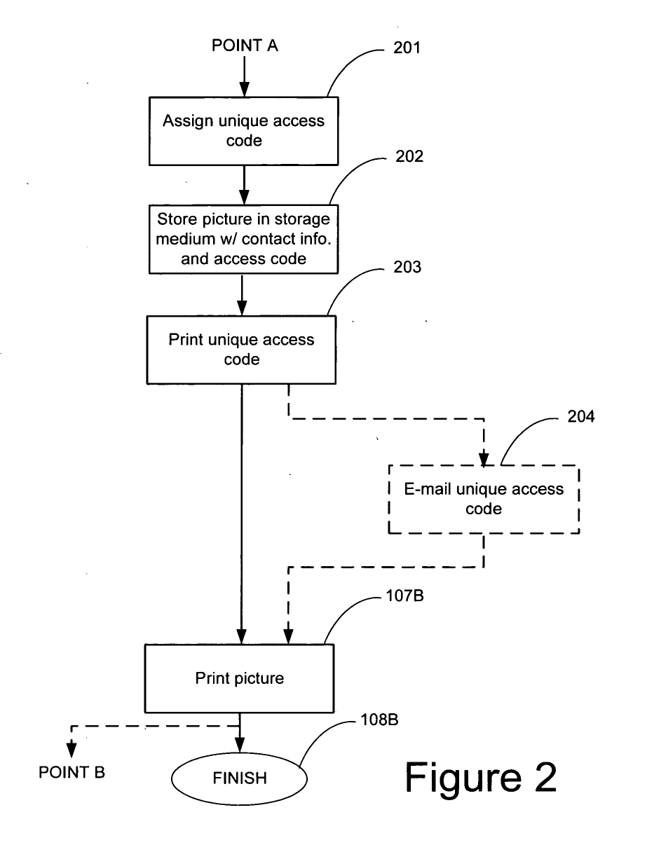

In another embodiment of the present invention, which is illustrated in FIG. 2 (FIG. 2 is a continuation of the flow diagram of FIG. 1A from POINT A, with the exclusion of steps 107A and 108A), the computer may be adapted to assign a random unique access code to the picture once taken (step 201) and to store a soft-copy of the picture in the storage medium, along with the contact information provided by the user and the assigned unique access code (step 202). Once the computer stores the picture in the storage medium (step 202), the computer prints the unique access code and provides it to the user (step 203). The computer may print the unique access code using the same printer as the one used to print the picture or may use a separate printer.

The computer may be adapted (programmed) to electronically mail the unique access code via the computer communication network to an electronic mail address provided by the user as a part of the contact information (step 204). This may be done as a precautionary step in case the user loses the printout of the unique access code provided to him in step 203. The computer then prints a hard-copy of the picture for the user (step 107B) and terminates the process (step 108B).

In accordance with the above-described embodiment, the user may at a later time gain access to the stored image via the computer communication network by identifying himself or herself (using the contact information or parts thereof, such as an entered electronic address), and by using the unique access code assigned to him or her. The process of using identification and access codes to gain access via a computer communication network to information (or pictures) stored within the storage medium of a computer (a remote server) is well known to those skilled in the art of computers and computer communication networks and will not be discussed further.

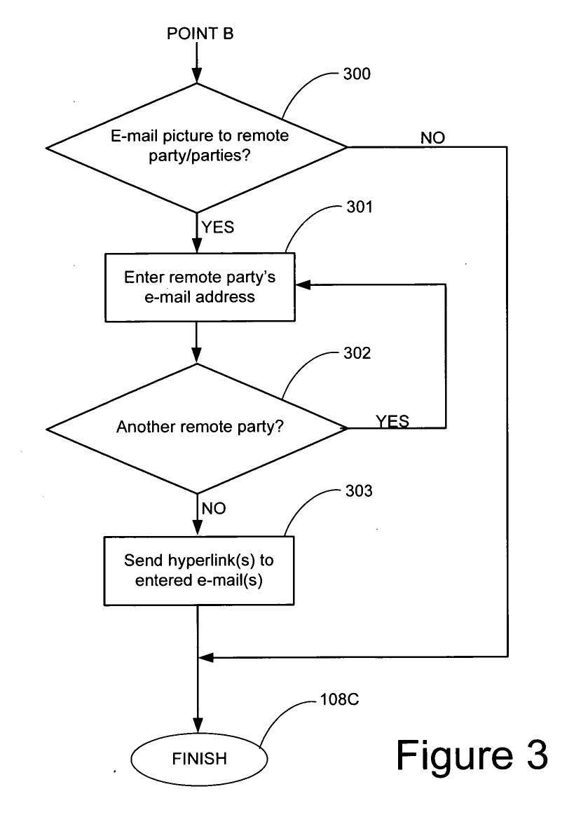

In yet another embodiment, the computer may be further adapted so that the user can opt to grant relatives and friends access to the stored picture. The steps associated with this procedure are shown in FIG. 3, where the computer is programmed to inquire if the user or user's nominee would like to grant a remote party (or remote parties) access to the stored picture (step 300). This is preferably done after step 107B of FIG. 2—namely, after printing the picture—so the user can answer the inquiry of step 300 after seeing the picture.

If the user's response to the inquiry of step 300 is negative, the process is completed (step 108C). If the user's response to the inquiry of step 300 is positive, the computer is programmed to inquire the electronic mail address of the first remote party to whom access to the stored picture is to be granted (step 301). After entering the electronic mail address of the first remote party, the computer inquires if the user or the user's nominee wishes to grant access to another remote party (step 302). If the answer to the inquiry of step 302 is positive, the computer inquires the electronic mail address of the other remote party (step 301).

The foregoing is repeated (loop of 301,302) until the user enters all the electronic mail addresses of the remote parties and responds negatively to the inquiry of step 302, at which point the computer transmits via the computer communication network hyperlink(s), preferably accompanied by a default message, to all of the electronic mail addresses entered with respect to step 301. The recipients of the hyperlinks may then utilize them to access copies of the stored picture. The process of using hyperlinks to gain access via a computer communication network to information (or pictures) stored within the storage medium of a remote server is also well known to those skilled in the art of computers and computer communication networks and will also not be discussed further.

In addition to promoting products and services of third party suppliers as described above, the system of the present invention may also include other promoting methods: the computer may be programmed to display on the display screen promotional information relating to the advertiser(s)—the third party supplier(s). Additionally, the system may include a second display screen, preferably a high-resolution display screen, for the purpose of continually displaying such promotional information.

I claim:

1. A system for taking an image of an object, said system comprising:
a station comprising at least one image-taking camera for taking said image of said object, a printer for printing the image to be taken, and an interactive computer terminal having a display screen and a keyboard, wherein said interactive computer terminal is in operative communication with a storage medium, and wherein said at least one image-taking camera, said printer, and said interactive computer terminal are in operative communication;
said interactive computer terminal being adapted to require the input of contact information relating to a user or said user's nominee, to store said contact information in said storage medium, and to query said user if said user or said nominee is interested in receiving at least one of object-related information, object-related goods and object-related services from one or more pre-selected third party sources, and to input either a positive or a negative response to said query;
means for actuating said at least one image-taking camera once said positive or negative response is inputted, and for causing said printer to print said image once taken;
said interactive computer terminal being linked to a computer communication network, wherein said contact information inputted by users with said positive response and stored in said storage medium is accessible via the computer communication network from a remote physical location by said one or more pre-selected third party sources.

2. The system of claim 1, wherein:
said system is adapted to store said image once taken in said storage medium along with said contact information and a unique access code assigned to said image by said interactive computer terminal;
said system is adapted to cause said printer or a second printer to print said unique access code; and
said image stored in said storage medium is accessible via the computer communication network from a second remote physical location by at least one of said user and said nominee utilizing said contact information and said access code.

3. The system of claim 2, wherein said contact information includes an electronic address relating to said user or said nominee, and said interactive computer terminal is adapted to transmit said unique access code to said electronic address via the computer communication network.

4. The system of claim 2, wherein said interactive computer terminal is adapted to further query said user if said user or said nominee wishes to grant access to the stored image via the computer communication network to at least one remote party located at a third remote physical location and having a remote-party electronic address, to input either a positive or a negative response to said further query, and if said response to said further query is positive, to require the additional input of the remote-party electronic address of each said at least one remote party for whom access is to be granted and transmit via the computer communication network a hyperlink to each inputted remote-party electronic address, wherein said at least one remote party can access the stored image by utilizing said hyperlink.

5. The system of claim 1 wherein said station further comprises at least one lamp in operative communication with said at least one image-taking camera for illuminating said object at the time said image is taken.

6. The system of claim 1 wherein said computer communication network is an World Wide Web.

7. The system of claim 1 wherein said display screen is an interactive touch display screen and said keyboard is an onscreen keyboard.

8. The system of claim 1 wherein promotional information relating to said one or more pre-selected third party sources appears on said display screen.

9. The system of claim 1 further comprising an advertising screen in operative communication with said interactive computer terminal for displaying promotional information relating to said one or more pre-selected third party sources.

10. The system of claim 9, wherein said advertising screen is a high-resolution advertising screen.

11. The system of claim 1 wherein the object is a newborn child and the station is a kiosk placed at a hospital.
